(19) United States
(12) Patent Application Publication
(10) Pub. No.: US 2009/0058765 A1
(43) Pub. Date: Mar. 5, 2009

(54) Plasma Display Device

(76) Inventors: Yasunobu Hashimoto, Kawasaki (JP); Masaki Kimura, Yokohama (JP); Tomokatsu Kishi, Yokosuka (JP); Katsumi Ito, Yokohama (JP); Naoki Itokawa, Yokohama (JP); Hideaki Ohki, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/183,673

(22) Filed: Jul. 31, 2008

(30) Foreign Application Priority Data
Aug. 28, 2007 (JP) 2007-221656
Nov. 19, 2007 (JP) 2007-299707

(51) Int. Cl. G09G 3/28

(52) U.S. Cl. 345/60

(57) ABSTRACT

Between a sustain circuit outputting a sustain pulse and a scan circuit (even) driving a Y electrode of an even display line, there is provided a first switch capable of making the Y electrode of the even display line be in a high impedance state, and between the sustain circuit and a scan circuit (odd) driving a Y electrode of an odd display line, there is provided a second switch capable of making the Y electrode of the odd display line be in the high impedance state. By first and second switches, the Y electrode of the even display line and the Y electrode of the odd display line can be independently controlled to be in the high impedance states, whereby discharge of the even display line can be restrained in a sustain period of an odd frame, while a discharge of the odd display line can be restrained in a sustain period of an even frame, thereby realizing an interlace drive without complicating a circuit configuration.

### CROSS-REFERENCE TO RELATED APPLICATIONS

This application is based upon and claims the benefit of priority from the prior Japanese Patent Application Nos. 2007-221656, filed on Aug. 28, 2007, and 2007-299707, filed on Nov. 19, 2007, the entire contents of which are incorporated herein by reference.

### BACKGROUND OF THE INVENTION

The present invention relates to a plasma display device.

Among plasma display panels (PDPs), there is a common electrode type plasma display panel (hereinafter, also referred to as “common electrode panel”), which has an electrode structure where neighboring cells have a common electrode (for example, see Japanese Patent Application Laid-open No. Hei 9-160525).

FIG. 16 is a block diagram showing a configuration of a plasma display device having a common electrode panel. The plasma display device has a plasma display panel (common electrode panel) 110, a Y electrode driver 120, an X electrode driver 130, an address driver 140, and a control circuit 150.

The Y electrode driver 120 is a drive circuit driving display electrodes (Y electrodes) Y1, Y2, . . . formed in the common electrode panel 110. The Y electrode driver 120 has scan circuits 121, 122 and sustain circuits 123, 124. The scan circuits 121, 122 operates to sequentially apply scan pulses to the display electrodes Y in an address period in which a cell (pixel) to be displayed is selected and to apply sustain pulses from the sustain circuits 123, 124 simultaneously to the display electrodes Y in a sustain period in which a sustain discharge is performed.

The X electrode driver 130 is a drive circuit driving display electrodes (X electrodes) X1, X2, . . . formed in the common electrode panel 110. The X electrode driver 130 has sustain circuits 131, 132. The sustain circuits 131, 132 apply sustain pulses to the display electrodes X in the sustain period. The address driver 140 applies address pulses to address electrodes A1, A2, . . . in correspondence with display data in the address period. The control circuit 150 generates a control signal based on inputted display data, clock signal, horizontal synchronization signal and vertical synchronization signal and the like. The control circuit 150 controls the Y electrode driver 120, the X electrode driver 130 and the address driver 140 by the generated control signal.

In the common electrode panel shown in FIG. 16, display lines are divided into odd display lines and even display lines, and the odd display lines are lighted in odd frames while the even display lines are lighted in even frames, whereby an interlace drive is performed. The odd display line is constituted with a set of an X electrode Xk (k=1, 2, . . . ) and a Y electrode Yk, while the even display line is constituted with a set of a Y electrode Yk and an X electrode X(k+1).

### SUMMARY OF THE INVENTION

In the above-described common electrode panel, since one display electrode lies across two neighboring display lines, it is necessary to apply different voltage waves (sustain pulses) to two display electrodes neighboring in relation to a certain display electrode in order to realize the interlace drive. In other words, it is necessary to apply the sustain pulses (applied voltages) in a manner to be in reverse phases to respective sets of display electrodes related to the display lines to be lighted and apply the sustain pulses in a manner to be in the same phase to respective sets of display electrodes related to display lines not to be lighted.

For instance, in an example shown in FIG. 16, when the odd display lines are to be lighted, voltage waveforms applied to the display electrode X1 and the display electrode Y1 are in a relation of reverse phase and voltage waveforms applied to the display electrode X2 and the display electrode Y2 are also in the relation of reverse phase. On the other hand, voltage waveforms applied to the display electrode Y1 and the display electrode X2 corresponding to the even display line are in a relation of the same phase.

In other words, when the odd display lines are to be lighted, with the display electrode Y1 being a reference, the voltage waveform of the same phase is applied to the display electrode X2 and the voltage waveforms of reverse phases are applied to the display electrodes X1, Y2. Similarly, when the even display lines are to be lighted, with the display electrode Y1 being a reference, the voltage waveform of the same phase is applied to the display electrode X1 and the voltage waveforms of reverse phases are applied to the display electrodes Y2.

As stated above, in order to realize the interlace drive in the common electrode panel, a Y electrode driver driving the Y electrode among the display electrodes must output two different kinds of voltage waveforms (sustain pulses) and similarly an X electrode driver driving the X electrode must output two different kinds of voltage waveforms (sustain pulses). As shown in FIG. 16, it is necessary to provide two sustain circuits in the Y electrode driver and the X electrode driver respectively, leading to a complicated circuit configuration.

An object of the present invention is to provide a plasma display device realizing an interlace drive without complicating a circuit configuration.

A plasma display device of the present invention includes: a plasma display panel in which one display line is constituted with a display electrode pair made of two electrodes and the display electrode pair of an even display line and the display electrode pair of an odd display line are alternately arranged; a first scan circuit to which a scan electrode of the display electrode pair of the even display line is connected and which supplies a drive voltage to the scan electrode; a second scan circuit to which a scan electrode of the display electrode pair of the odd display line is connected and which supplies a drive voltage to the scan electrode; a first sustain circuit outputting one kind of sustain pulse applied to the scan electrode of the display electrode pair; a first switch circuit being a switch circuit connecting the first sustain circuit and the first scan circuit and capable of making the scan electrode of the even display line be in a high impedance state; and a second switch circuit being a switch circuit connecting the first sustain circuit and the second scan circuit and capable of making the scan electrode of the odd display line be in the high impedance state.

According to the present invention, by the first switch circuit and the second switch circuit, it is possible to control the scan electrode of the even display line and the scan electrode of the odd display line independently to make the scan electrodes be in high impedance states. Thereby, a discharge of the even display line is restrained in a sustain period of an odd frame and a discharge of the odd display line is restrained in a sustain period of an even frame, so that an interlace drive can be realized with a simple circuit configuration.

### BRIEF DESCRIPTION OF THE DRAWINGS

FIG. 1 is a diagram showing a configuration example of a plasma display device according to a first embodiment of the present invention;

FIG. 2 is a diagram showing a configuration example of a plasma display panel in the first embodiment;

FIG. 3 is a diagram to explain a disposition of display electrodes in the plasma display panel in the first embodiment;

FIG. 4A and FIG. 4B are diagrams to explain a drive method of a plasma display panel;

FIG. 5 is a diagram showing an example of drive waveforms of the plasma display device in the first embodiment;

FIG. 6 is a diagram showing an example of drive waveforms of a plasma display device in a second embodiment;

FIG. 7 is a diagram to explain a drive configuration in the second embodiment;

FIG. 8 is a diagram to explain a configuration of a sub-frame in the second embodiment;

FIG. 9 is a graph showing an example of mixing ratio control of two line lighting;

FIG. 10A and FIG. 10B are graphs to explain APC control;

FIG. 11A and FIG. 11B are graphs showing an example of mixing ratio control of two line lighting;

FIG. 12A and FIG. 12B are graphs showing another example of mixing ratio control of two line lighting;

FIG. 13 is a graph showing still another example of mixing ratio control of two line lighting;

FIG. 14A and FIG. 14B are graphs showing a control example in a fourth embodiment;

FIG. 15 is a diagram showing an example of drive waveforms in an upper sub-frame of a plasma display device in the fourth embodiment;

FIG. 16 is a diagram showing a configuration of a plasma display device having a common electrode type plasma display panel;

FIG. 17A and FIG. 17B are diagrams to explain an example of drive waveforms of a plasma display device in a third embodiment; and

FIG. 18A and FIG. 18B are diagrams to explain another example of drive waveforms of the plasma display device in the third embodiment.

### DETAILED DESCRIPTION OF THE PREFERRED EMBODIMENTS

Hereinafter, embodiments of the present invention will be described based on the drawings.

### First Embodiment

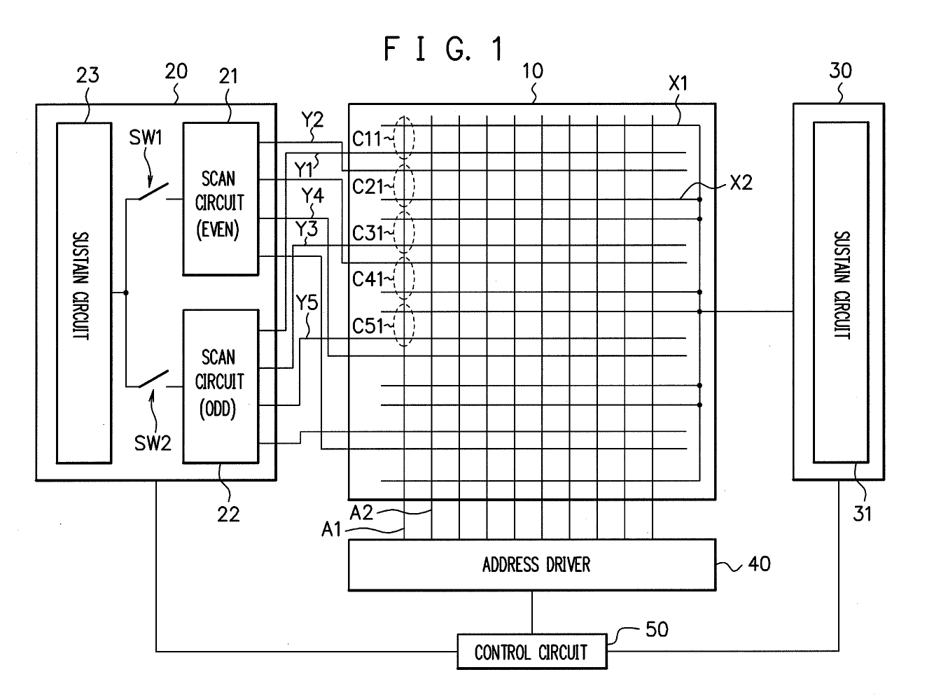

FIG. 1 is a block diagram showing a configuration example of a plasma display device according to a first embodiment of the present invention. The plasma display device according to the first embodiment has a plasma display panel 10, a Y electrode driver 20, an X electrode driver 30, an address driver 40 and a control circuit 50.

The Y electrode driver 20 is a circuit to drive Y electrodes (scan electrodes) Y1, Y2, . . . among display electrodes. The Y electrode driver 20 has a scan circuit (even) 21, a scan circuit (odd) 22 and a sustain circuit 23. Hereinafter, each of the Y electrodes Y1, Y2, . . . is also referred to or generically named as a Y electrode Yi, the i meaning a subscript.

The scan circuits 21, 22 are constituted with circuits performing line-sequential scanning to select a row to be displayed. The sustain circuit 23 is constituted with a circuit repeating sustain discharges. Predetermined voltages are supplied to a plurality of Y electrodes Yi by the scan circuits 21, 22 and the sustain circuit 23.

The scan circuit (even) 21 is provided in correspondence with even-th Y electrodes Y2, Y4, . . . related to even display lines among the display lines, and supplies drive voltages to the Y electrodes Y2, Y4, . . . . The scan circuit (even) 21 operates so that, in at least even frames in which the even display lines are lighted, scan pulses are sequentially applied to the Y electrodes Y2, Y4, . . . in an address period, and sustain pulses from the sustain circuit 23 are simultaneously applied to the Y electrodes Y2, Y4, . . . in a sustain period.

Similarly, the scan circuit (odd) 22 is provided in correspondence with odd-th Y electrodes Y1, Y3, Y5, . . . related to the odd display lines and supplies drive voltages to the Y electrodes Y1, Y3, Y5, . . . . The scan circuit (odd) 22 operates so that, in at least odd frames in which the odd display lines are lighted, scan pulses are sequentially applied to the Y electrodes Y1, Y3, . . . in the address period, and sustain pulses from the sustain circuit 23 are simultaneously applied to the Y electrodes Y1, Y3, . . . in the sustain period.

The scan circuit (even) 21 and the sustain circuit 23 are connected via a switch SW1, while the scan circuit (odd) 22 and the sustain circuit 23 are connected via a switch SW2. The switches SW1, SW2 are independently on/off-controlled based on a control signal and the like from the control circuit 50.

By the switches SW1, SW2, it is possible to independently switch whether or not to supply an output from the sustain circuit 23 to the scan circuits 21, 22, more specifically, to switch by the switch SW1 whether or not to apply the output from the sustain circuit 23 to the even-th Y electrodes Y2, Y4, . . . , and to switch by the switch SW2 whether or not to apply the output from the sustain circuit 23 to the odd-th Y electrodes Y1, Y3, . . . , respectively. Further, making the switches SW1, SW2 be in off states enables independently making the even-th Y electrodes Y2, Y4, . . . and the odd-th Y electrodes Y1, Y3, . . . in high-impedance states.

The X electrode driver 30 is a circuit to drive X electrodes (sustain electrodes) X1, X2, . . . among display electrodes. The X electrode driver 30 has a sustain circuit 31. Hereinafter, each of the X electrodes X1, X2, . . . is also referred to or generically named as an X electrode Xi, the i meaning a subscript. The sustain circuit 31 is constituted with a circuit repeating sustain discharges and supplies a predetermined voltage to the X electrode Xi. The X electrodes Xi are common-connected in one end to the X electrode driver 30.

The address driver 40 is constituted with a circuit selecting a column to be displayed and supplies predetermined voltages to a plurality of address electrodes A1, A2, . . . . Hereinafter, each of the address electrodes A1, A2, . . . is also referred to or generically named as an address electrode Aj, the j meaning a subscript.

The control circuit 50 generates the control signal based on display data, a clock signal, a horizontal synchronization signal, a vertical synchronization signal and the like which are inputted from the outside. The control circuit 50 supplies the generated control signal to the Y electrode driver 20, the X electrode driver 30, and the address driver 40 to control these drivers 20, 30, 40.

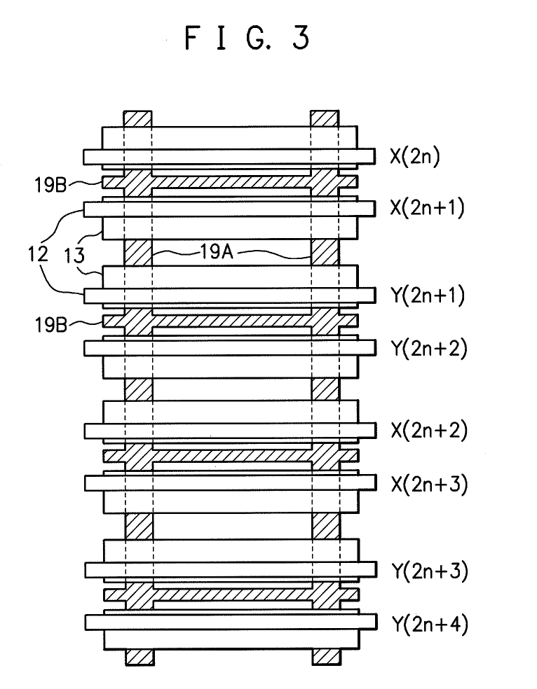

In the plasma display panel 10, the Y electrode Yi and the X electrode Xi which constitute a display electrode pair form rows extending parallelly in a horizontal direction, while the address electrode Aj forms a column extending in a vertical direction. The Y electrode Yi and the X electrode Xi are arranged in a predetermined disposition pattern (a disposition pattern of the display electrode will be described later with reference to FIG. 3) in the vertical direction and parallelly to each other. The address electrode Aj is disposed in a direction almost perpendicular to the Y electrode Yi and the X electrode Xi. The Y electrode Yi and the address electrode Aj form a two-dimensional matrix of i-row and j-column.

Here, in the plasma display panel 10 in the present embodiment, a display electrode pair constituted with two electrodes (a pair of Y electrode Yi and X electrode Xi) is disposed for one display line and the display electrode is not shared by neighboring display lines. In other words, with the p being a natural number, the odd display line among the display lines is constituted with a set of Y electrode Y(2p−1) and X electrode X(2p−1) and the even display line is constituted with a set of Y electrode Y(2p) and X electrode X(2p). For instance, a first display line is constituted with a set of Y electrode Y1 and X electrode X1 and a second display line is constituted with a set of Y electrode Y2 and X electrode X2.

A cell Cij is formed by an intersection point of the Y electrode Yi and the address electrode Aj, and the X electrode Xi neighboring in correspondence therewith. The cell Cij corresponds to a sub-pixel of, for example, red, green, or blue and sub-pixels of these three colors constitute one pixel. The panel 10 displays an image by lighting a plurality of two dimensionally aligned pixels. Which cell to light is determined by the scan circuits 21, 22 in the Y electrode driver 20 and the address driver 40, and discharges are repeatedly performed by the sustain circuit 23 in the Y electrode driver 20 and the sustain circuit 31 in the X electrode driver 30, whereby a display operation is performed.

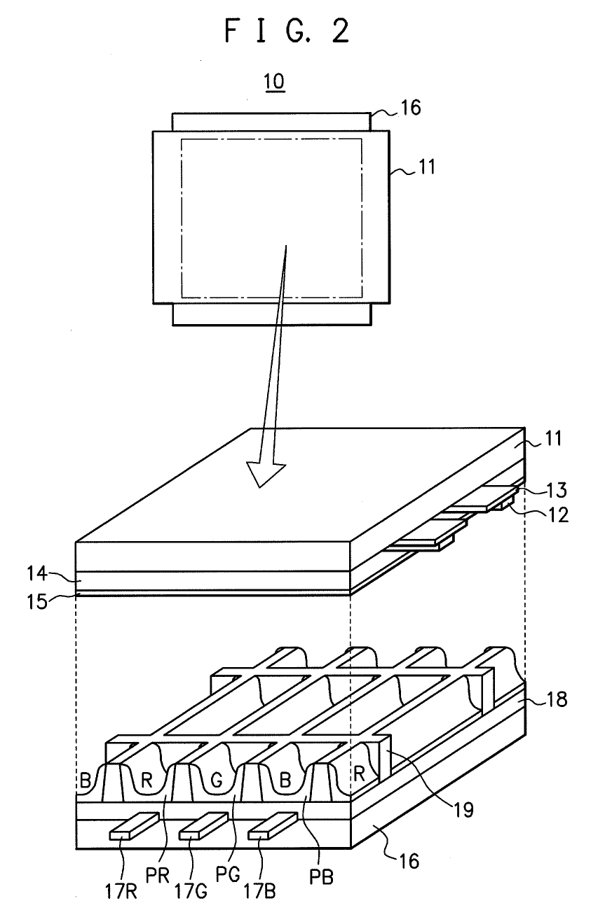

FIG. 2 is an exploded perspective view showing a configuration example of the plasma display panel 10 in the first embodiment.

On a front glass substrate 11, there is formed a display electrode made of a bus electrode (metal electrode) 12 and a transparent electrode 13. The display electrodes (12, 13) correspond to the Y electrode Yi and the X electrode Xi shown in FIG. 1. A dielectric layer 14 is provided on the display electrode (12, 13) and further a protective layer 15 of MgO (magnesium oxide) is provided thereon. In other words, the display electrode (12, 13) disposed on the front glass substrate 11 is covered by the dielectric layer 14 and a surface thereof is further covered by the MgO protective layer 15.

On a rear glass substrate 16 disposed to face the front glass substrate 11, there are formed address electrodes 17R, 17G, 17B in a direction orthogonal to (crosswise to) the display electrode (12, 13). The address electrodes 17R, 17G, 17B correspond to the address electrodes Aj shown in FIG. 1. A dielectric layer 18 is formed on the address electrodes 17R, 17G, 17B.

Further, on the dielectric layer 18, there are formed closed ribs 19 disposed in a lattice shape, that is, dividing a discharge space by every cell, and phosphor layers PR, PG, PB emitting visible lights of red (R), green (G) and blue (B) for color displaying. The phosphor layers PR, PG, PB are excited by an ultraviolet ray generated by a surface discharge between the display electrodes (12, 13) in pair.

The ribs 19 are made of vertical ribs formed in a direction in which the address electrodes 17R, 17G, 17B extend and horizontal ribs formed in a direction in which the display electrode (12, 13) extends. In other words, the plasma display panel 10 according to the present invention has a closed rib structure.

The phosphor layer PR emitting red light is formed above the address electrode 17R, the phosphor layer PG emitting green light is formed above the address electrode 17G, and the phosphor layer PB emitting blue light is formed above the address electrode 17B. In other words, the address electrodes 17R, 17G, 17B are disposed to correspond to the red, green and blue phosphor layers PR, PG, PB applied to inner surfaces of ribs 19 corresponding to the cells.

The plasma display panel 10 is constituted by sealing the front glass substrate 11 and the rear glass substrate 16 in a manner that the protective layer 15 contacts the ribs 19 and by filling discharge gas such as Ne—Xe into the inside (in the discharge space between the front glass substrate 11 and the rear glass substrate 16) thereof.

FIG. 3 is a diagram to explain a disposition of the display electrodes in the plasma display panel in the first embodiment.

Vertical ribs 19A are formed on both sides of the not-shown address electrode Aj and horizontal ribs 19B are formed to intersect the vertical ribs 19A. The discharge space is divided by the vertical ribs 19A and the horizontal ribs 19B to form a cell, and a display line is formed with a plurality of cells lined in a horizontal direction (direction in which the horizontal rib 19B extends).

In the direction in which the horizontal rib 19B extends, the display electrode made of the bus electrode 12 and the transparent electrode 13 is formed, and a pair of (two) display electrodes (12, 13) is disposed for each display line without sharing the display electrode with a neighboring display line. The display electrodes (12, 13) are disposed in a manner that disposed positions of the X electrodes and the Y electrodes are reverse to each other in the neighboring display lines. For example, as shown in FIG. 3, when an X electrode X(2n+1) and a Y electrode Y(2n+1) are disposed in that order in a (2n+1)th display line, a Y electrode Y(2n+2) and an X electrode X(2n+2) are disposed in that order in a display line (2n+2) neighboring thereto. In other words, it is disposed in a manner that, the X electrodes in the neighboring display lines lie side by side with each other or the Y electrodes in the neighboring display lines lie side by side with each other, across the horizontal rib 19B.

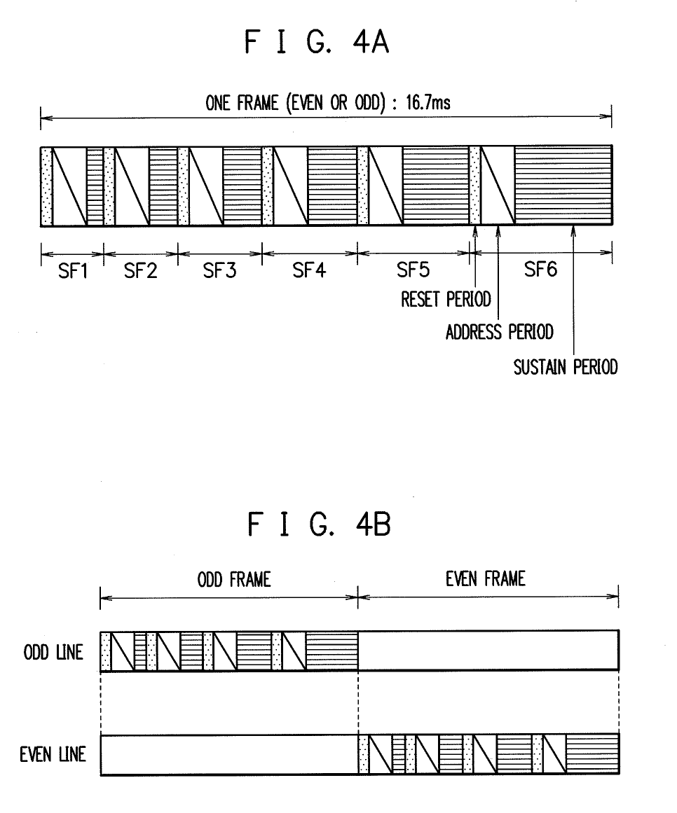

A drive method of a commonly used plasma display panel will be described with reference to FIG. 4A and FIG. 4B.

FIG. 4A is a diagram to explain an example of a drive method of a plasma display panel. One frame (an odd frame or an even frame) is constituted with a plurality of sub-frames (SF). In FIG. 4A, a configuration in which one frame is made of six sub-frames SF1, SF2, SF3, SF4, SF5, SF6 is shown for convenience of illustration, but usually, a configuration made of 10 to 12 sub-frames is generally used.

Each of sub-frames SF1 to SF6 is constituted with a reset period, an address period and a sustain period. In the reset period, a wall charge state on an electrode is initialized. In the address period, the wall charge state is adjusted based on display data and a cell to be lighted is selected. In the sustain period, the cell corresponding to the display data is lighted (the cell selected in correspondence with the display data is made to perform discharge light emission). By selecting light emission or non light emission in the sub-frames SF1 to SF6, gradation expression is realized.

FIG. 4B is a diagram to explain an example of an interlace drive of the plasma display panel. In FIG. 4B, a configuration is that the odd frame and the even frame are made of four sub-frames, for convenience of illustration. In the odd frame, an odd display line is lighted and an even display line is not lighted. In the even frame, the even display line is lighted and the odd display line is not lighted.

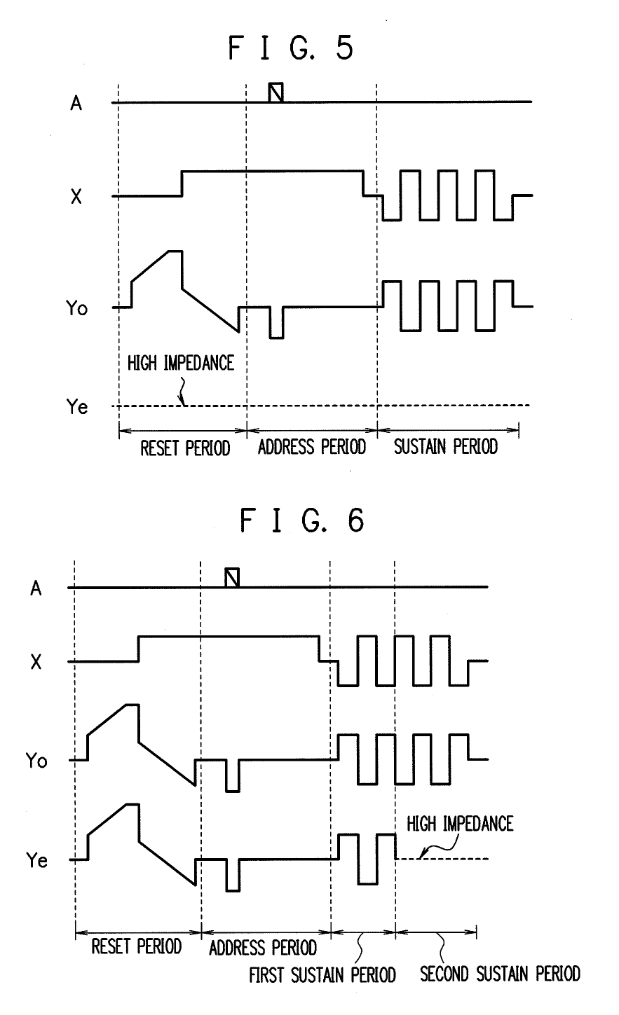

FIG. 5 is a graph showing an example of drive waveforms of the plasma display device in the first embodiment. In FIG. 5, there is shown the example of drive waveforms related to the X electrode Xi, Y electrode Yi, and the address electrode Aj in one sub-frame among the plurality of sub-frames constituting the odd frame. In FIG. 5, “A” indicates a voltage waveform applied to the address electrode Aj, “X” indicates a voltage waveform applied to the X electrode Xi, “Yo” indicates a voltage waveform applied to the Y electrode Yi of the odd display line, and “Ye” indicates a voltage waveform applied to the Y electrode Yi of the even display line.

In the first embodiment, in the odd frame, the switch SW2 to connect the scan circuit (odd) 22 and the sustain circuit 23 in the Y electrode drive 20 is made to be in an ON state.

In the reset period, initialization of a cell Cij is performed. In the example shown in FIG. 5, in the reset period, a ramp wave of a positive polarity (waveform having positive inclination) is simultaneously applied to the Y electrodes Yi (Yo) of the odd display lines to form a wall charge, and subsequently a ramp wave of a negative polarity (waveform having negative inclination) is simultaneously applied to the Y electrodes Yi (Yo) to adjust a wall charge amount of the cell Cij.

In the address period, there is performed a scan operation to select lighting or non-lighting of each cell Cij of the odd display lines by addressing. In the address period, scan pulses are sequentially applied to the Y electrodes Y1, Y3, . . . (Yo) of the odd display lines, and the address pulses are applied to the address electrode Aj in correspondence with the scan pulses. Thereby, a discharge occurs between the address electrode Aj and the Y electrode Yi (Yo) of the odd display line, and a wall charge is formed on the X electrode Xi and the Y electrode Yi (Yo) by this discharge, and lighting or non-lighting of the cell Cij is selected.

If the address pulse of the address electrode Aj is generated in correspondence with the scan pulse of the Y electrode Yi, lighting of the cell Cij formed by the Y electrode Yi as well as X electrode Xi and the address electrode Aj is selected. If the address pulse of the address electrode Aj is not generated in correspondence with the scan pulse of the Y electrode Yi, lighting of the cell Cij formed by the Y electrode Yi as well as the X electrode Xi and the address electrode Aj is not selected and non-lighting is selected.

In the sustain period, reverse sustain pulses to each other are applied to the X electrode Xi and the Y electrode Yi (Yo) of the odd display line to perform a sustain discharge between the X electrode Xi and the Y electrode Yi (Yo) of the cell selected in the address period, and light emission is performed.

In the first embodiment, in the sub-frame constituting the odd frame, the switch SW1 connecting the scan circuit (even) 21 and the sustain circuit 23 in the Y electrode driver 20 is made to be in an OFF state, so that the Y electrode Yi (Ye) of the even display line is high impedance, as shown in FIG. 5. In the example shown in FIG. 5, the Y electrode Yi (Ye) in the even display line is made to be in a high impedance state in the reset period, the address period and the sustain period, but the Y electrode Yi (Ye) can also be made to be in the high impedance state at least in the sustain period.

It should be noted that the same things apply to the sub-frame constituting the even frame. In the even frame, and the switch SW1 connecting the scan circuit (even) 21 and the sustain circuit 23 in the Y electrode driver 20 is made to be in the ON state and the switch SW2 connecting the scan circuit (odd) 22 and the sustain circuit 23 is made to be in the OFF state. In other words, in the sub-frame in the even frame, a drive waveform similar to that of the Y electrode Yi (Yo) of the odd display line shown in FIG. 5 is applied to the Y electrode Yi (Ye) of the even display line, and the Y electrode Yi (Yo) of the odd display line is high impedance.

As stated above, according to the first embodiment, in the Y electrode driver 20, the scan circuit (even) 21 corresponding to the even display line and the sustain circuit 23 are connected via the switch SW1 and the scan circuit (odd) 22 corresponding to the odd display line and the sustain circuit 23 are connected via the switch SW2. At least in the sustain period of the odd frame, the switch SW1 is made to be in the OFF state to make the Y electrode Yi (Ye) of the even display line be high impedance. At least in the sustain period of the odd frame, the switch SW2 is made to be in the OFF state to make the Y electrode Yi (Yo) of the odd display line be high impedance. Thus, the interlace drive can be realized by restraining the discharge of the even display line in the sustain period of the odd frame and restraining the discharge of the odd display line in the sustain period of the even frame.

In the sustain period, the voltage waveform applied to the Y electrode Yi (Ye, Yo) by the sustain circuit 23 in the Y electrode driver 20 and the voltage waveform applied to the X electrode Xi by the sustain circuit 31 in the X electrode driver 30 are, respectively, of one kind. Therefore, it suffices to provide the Y electrode driver 20 and the X electrode driver 30 with one monophase sustain circuit for each of sustain circuit 23 and the sustain circuit 31, so that the interlace drive becomes feasible with a simple circuit configuration.

### Second Embodiment

Next, a second embodiment of the present invention will be described.

In the above-described first embodiment, in the sustain period of the odd frame the switch SW1 is made to be in the OFF state to make the Y electrode Yi (Ye) of the even display line be in the high impedance state, while in the sustain period of the even frame the switch SW2 is made to be in the OFF state to make the Y electrode Yi (Yo) of the odd display line be in the high impedance state.

In contrast, in the second embodiment described below, a sustain period is divided into a first sustain period and a second sustain period. It is controlled that in the first sustain period sustain pulses are applied to both of Y electrodes Yi (Ye, Yo) of even display line and odd display line, and in the second sustain period the Y electrode Yi (Ye) of the even display line is made to be high impedance in a case of an odd frame while the Y electrode Yi (Yo) of the odd display line is made to be high impedance in a case of an even frame.

A configuration of a plasma display device in the second embodiment is similar to the configuration of the plasma display device in the first embodiment, and explanation thereof will be omitted.

An operation of the plasma display device in the second embodiment will be described.

In the second embodiment, a switch SW1 connecting the scan circuit (even) 21 and the sustain circuit 23 is in an OFF state in the second sustain period of the odd frame, while a switch SW2 connecting the scan circuit (odd) 22 and the sustain circuit 23 is in the OFF state in the second sustain period of the even frame. In other periods, both the switches SW1 and SW2 are in ON states.

FIG. 6 is a graph showing an example of drive waveforms of the plasma display device in the second embodiment. In FIG. 6, there is shown the example of drive waveforms related to the X electrode Xi, Y electrode Yi, and an address electrode Aj in one sub-frame among a plurality of sub-frames constituting the odd frame. In FIG. 6, “A” indicates a voltage waveform applied to the address electrode Aj, “X” indicates a voltage waveform applied to the X electrode Xi, “Yo” indicates a voltage waveform applied to the Y electrode Yi of the odd display line, and “Ye” indicates a voltage waveform applied to the Y electrode Yi of the even display line.

In a reset period, initialization of a cell Cij is performed. In the reset period, a ramp wave of a positive polarity is simultaneously applied to the Y electrodes Yi (Yo and Ye) to form a wall charge, and subsequently a ramp wave of a negative polarity is simultaneously applied to the Y electrodes Yi (Yo and Ye) to adjust a wall charge amount of the cell Cij.

In an address period, by a scan pulse being sequentially applied to the Y electrodes Yi and address pulses being applied to the address electrode Aj in correspondence with data (by addressing), a scan operation to select lighting or non-lighting of each cell Cij is performed. In the address period in the second embodiment, in a case of the odd frame, the scan operations are simultaneously performed to a (2n+1)th line being the odd display line and a (2n+2)th line being the even display line, and the same data is written to corresponding cells. In a case of the even frame, the scan operations are simultaneously performed to a (2n+2)th line being the even display line and a (2n+3)th line being the odd display line, and the same data is written to corresponding cells.

In other words, in the second embodiment, the scan operations are performed, with neighboring one odd display line and one even display line being a set, and the same data is written to the cells to which the two lines correspond. For example, in the odd frame, data written to a cell C11 shown in FIG. 1 is also written to a cell C21, and data written to a cell C31 is also written to a cell C41. Similarly, in the even frame, data written to the cell C21 shown in FIG. 1 is also written to the cell C31, and data written to the cell C41 is also written to a cell C51. It should be noted that the scan operations may be simultaneously performed to the (2n+1)th line and a (2n)th line in the case of the odd frame and that the scan operations may be simultaneously performed to the (2n+2)th line and the (2n+1)th line in the case of the even frame.

In the first sustain period, reverse sustain pulses to each other are applied to the X electrode Xi and the Y electrode Yi (Yo and Ye) to perform a sustain discharge between the X electrode Xi and the Y electrode Yi (Yo and Ye) in the cell selected in the address period, and light emission is performed. It should be noted that in the first sustain period the sustain pulses applied to the Y electrode Yo and the Y electrode Ye are in the same phase.

In the subsequent second sustain period, reverse sustain pulses to each other are applied to the X electrode Xi and the Y electrode Yi (Yo) of the odd display line to perform a sustain discharge between the X electrode Xi and the Y electrode Yi (Yo) of the cell selected in the address period, and light emission is performed. On the other hand, as shown in FIG. 6, in the second sustain period of the odd frame, the switch SW1 connecting the scan circuit (even) 21 and the sustain circuit 23 is made to be in the OFF state and the Y electrode Yi (Ye) of the even display line becomes high impedance.

The same things apply to the sub-frame constituting the even frame, and in the second sustain period of the even frame the switch SW2 connecting the scan circuit (odd) 22 and the sustain circuit 23 is made to be in the OFF state and the Y electrode Yi (Yo) of the odd display line becomes high impedance.

According to the second embodiment, in the first sustain periods of the odd frame and the even frame, both of the switches SW1 and SW2 are made to be in the ON states and display operations are simultaneously performed with the two lines being a set. Here, if the two lines in set are regarded as one line, the odd frame and the even frame are displayed in different display line positions. Therefore, in the first sustain period, an interlace drive with two line display is realized.

In the second sustain period of the odd frame, the switch SW1 is made to be in the OFF state, while in the second sustain period of the even frame, the switch SW2 is made to be in the OFF state. In this way, in the second sustain period of the odd frame, the Y electrode Yi (Ye) of the even display line is made to be in the high impedance state to restrain the discharge in the even display line, while in the second sustain period of the even frame, the Y electrode Yi (Yo) of the odd display line is made to be in the high impedance state to restrain the discharge in the odd display line. Therefore, in the second sustain period, an interlace drive with one line display can be realized.

Similarly to in the first embodiment, in the first and second sustain periods, a voltage waveform applied to the Y electrode Yi (Ye, Yo) by the sustain circuit 23 in the Y electrode driver 20 and a voltage waveform applied to the X electrode Xi by the sustain circuit 31 in the X electrode driver 30 are one kind, respectively. Therefore, it suffices to provide the Y electrode driver 20 and the X electrode driver 30 with one monophase sustain circuit for each of sustain circuit 23 and the sustain circuit 31, so that the interlace drive becomes feasible with a simple circuit configuration.

### Third Embodiment

Next, a third embodiment of the present invention will be described.

In the third embodiment, similarly to in the second embodiment, a sustain period is divided into a first sustain period and a second sustain period. In the first sustain period, it is controlled that sustain pulses are applied to both of Y electrodes Yi (Ye, Yo) of an even display line and an odd display line. In the second sustain period, it is controlled that a sustain pulse is applied to the Y electrode Yi (Yo) of the odd display line to make the Y electrode Yi (Ye) of an even display line be in a high impedance state in a case of an odd frame, and that a sustain pulse is applied to the Y electrode Yi (Ye) of the even display line to make the Y electrode Yi (Yo) of the odd display line be in the high impedance state in a case of an even frame.

In other words, in the first sustain period of the odd frame, in a Y electrode driver 20, both a switch SW1 to connect a scan circuit (even) 21 and a sustain circuit 23 as well as a switch SW2 to connect a scan circuit (odd) 22 and the sustain circuit 23 are made to be in ON states. In the second sustain period of the odd frame, the switch SW2 is made to be in the ON state and the switch SW1 is made to be in an OFF state. In the first sustain period of the even frame, both the switches SW1 and SW2 are made to be in the ON states, and in the second sustain period of the even frame, the switch SW1 is made to be in the ON state and the switch SW2 is made to be in the OFF state.

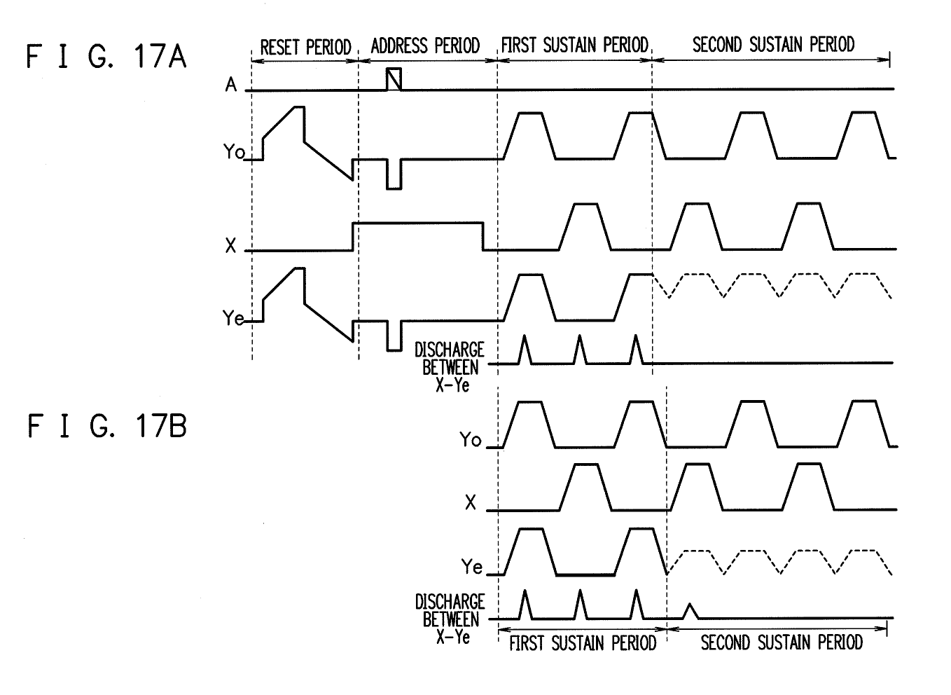

FIG. 17A is a graph showing an example of drive waveforms of a plasma display device in the third embodiment. In FIG. 17A, there is shown the example of drive waveforms related to the X electrode Xi, Y electrode Yi, and the address electrode Aj in one sub-frame among the plurality of sub-frames constituting the odd frame. In FIG. 17A, “A” indicates a voltage waveform related to the address electrode Aj, “Yo” indicates a voltage waveform related to the Y electrode Yi of the odd display line, “X” indicates a voltage waveform related to the X electrode, and “Ye” indicates a voltage waveform related to the Y electrode Yi of the even display line.

In a reset period, initialization of a cell Cij is performed. In the example shown in FIG. 17A, in the reset period, a ramp wave of a positive polarity is simultaneously applied to the Y electrodes Yi (Yo and Ye) to form a wall charge, and subsequently a ramp wave of a negative polarity is simultaneously applied to the Y electrodes Yi (Yo and Ye) to adjust a wall charge amount of the cell Cij.

In an address period, there is performed a scan operation to select lighting or non-lighting of each cell Cij by addressing. In the address period, scan pulses are sequentially applied to the Y electrodes Yi and the address pulses are applied to the address electrodes Aj in correspondence with the scan pulses. Thereby, a discharge occurs between the address electrode Aj and the Y electrode Yi, and by this discharge, a wall charge is formed on the X electrode Xi and the Y electrode Yi, so that lighting or non-lighting of the cell Cij is selected.

If the address pulse of the address electrode Aj is generated in correspondence with the scan pulse of the Y electrode Yi, lighting of the cell Cij formed by the Y electrode Yi as well as the X electrode Xi and the address electrode Aj is selected. If the address pulse of the address electrode Aj is not generated in correspondence with the scan pulse of the Y electrode Yi, lighting of the cell Cij formed by the Y electrode Yi as well as the X electrode Xi and the address electrode Aj is not selected and non-lighting is selected.

In the address period in the present embodiment, in a case of the odd frame, the scan operations are simultaneously performed to a (2n+1)th line being the odd display line and a (2n+2)th line being the even display line, and the same data is written to corresponding cells in accordance with identical data. In a case of the even frame, the scan operations are simultaneously performed to a (2n+2)th line being the even display line and a (2n+3)th line being the odd display line in accordance with identical data, and the same data is written to corresponding cells.

In other words, in the present embodiment, the scan operations are performed, with neighboring one odd display line and one even display line being a set, and the same data is written to the cells to which the two lines correspond. For example, in the odd frame, data written to a cell C11 shown in FIG. 1 is also written to a cell C21, and data written to a cell C31 is also written to a cell C41. Similarly, in the even frame, data written to the cell C21 shown in FIG. 1 is also written to the cell C31, and data written to the cell C41 is also written to a cell C51. It should be noted that the scan operations may be simultaneously performed to the (2n+1)th line and a (2n)th line in the case of the odd frame and that the scan operations may be simultaneously performed to the (2n+2)th line and the (2n+1)th line in the case of the even frame.

In the first sustain period, sustain pulses are alternately applied to the X electrode Xi and the Y electrode Yi (Yo and Ye) to perform a sustain discharge between the X electrode Xi and the Y electrode Yi (Yo and Ye) of the cell selected in the address period, and light emission is performed. It should be noted that in the first sustain period the sustain pulses applied to the Y electrode Yo and the Y electrode Ye are in the same phase.

In the subsequent second sustain period, sustain pulses are alternately applied to the X electrode Xi and the Y electrode Yi (Yo) of the odd display line to perform a sustain discharge between the X electrode Xi and the Y electrode Yi (Yo) of the cell selected in the address period, and light emission is performed. On the other hand, as shown in FIG. 17A, in the second sustain period of the odd frame, the switch SW1 connecting the scan circuit (even) 21 and the sustain circuit 23 is made to be in the OFF state and the Y electrode Yi (Ye) of the even display line becomes high impedance. Therefore, as shown in FIG. 17A, in the second sustain period, an electric potential of the Y electrode Yi (Ye) of the even display line changes in correspondence with a voltage applied to the X electrode Xi or the Y electrode Yi (Yo) of the odd display line.

Here, in the example shown in FIG. 17A, when the sustain pulse is applied to the X electrode Xi or the Y electrode Yi, it is driven so that the voltage applied to one of the electrodes Xi and Yi is set up after the applied voltages to both the electrodes Xi and Yi become in low levels (in the present embodiment, ground levels). The present applicant observes that, when the plasma display device is driven as above, an error discharge may occur between the X electrode Xi and the Y electrode Yi (Ye) if the high impedance state is brought about by making the switch SW1 to be in the OFF state from in the ON state after making the applied voltage to the Y electrode Yi (Ye) of the even display line be in a low level, as shown in a reference waveform in FIG. 17B.

Thus, in the present embodiment, as shown in FIG. 17A, at a voltage state where a final sustain discharge in the first sustain period is performed, transition from the first sustain period to the second sustain period is done, that is, the switch SW1 is made from in the ON state to in the OFF state and the Y electrode Yi (Ye) of the even display line is made to be in the high impedance state. In other words, when performing the driving as shown in FIG. 17A, the switch SW1 is made from in the ON state to in the OFF state with the applied voltage to the Y electrode Yi (Ye) of the even display line being in a high level. Thereby, in the second sustain period, occurrence of an error discharge between the X electrode Xi and the Y electrode Yi (Ye) of the even display line can be restrained, so that deterioration of a display quality (a drive margin) can be prevented.

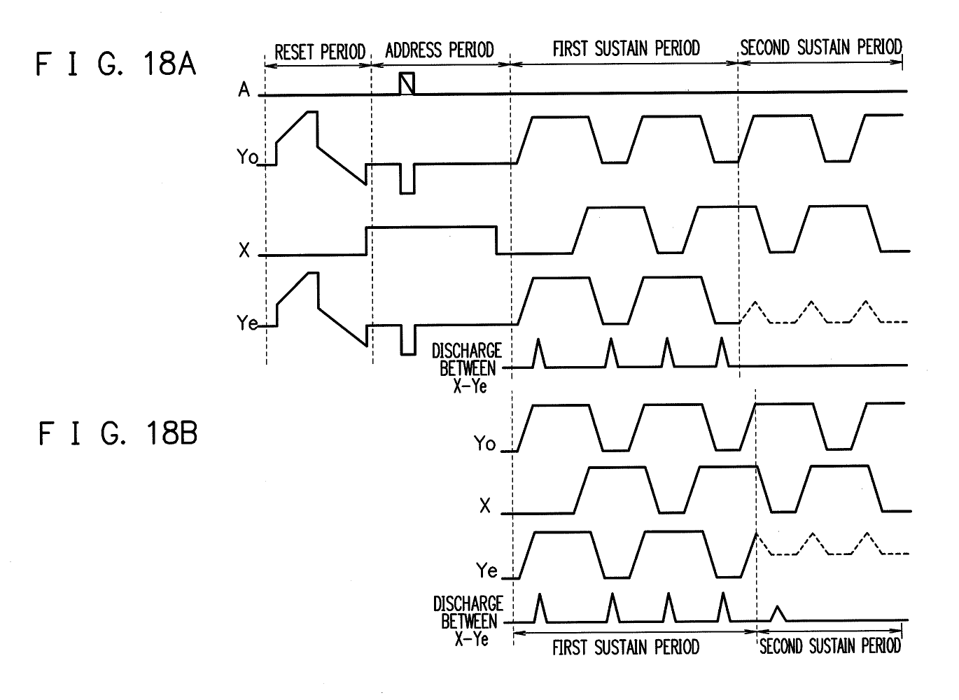

FIG. 18A is a graph showing another example of drive waveforms of the plasma display device in the present embodiment. In FIG. 18A there is shown the example of drive waveforms related to the X electrode Xi, Y electrode Yi, and the address electrode Aj in one sub-frame among the plurality of sub-frames constituting the odd frame. In FIG. 18A, “A” indicates a voltage waveform related to the address electrode Aj, “Yo” indicates a voltage waveform related to the Y electrode Yi of the odd display line, “X” indicates a voltage waveform related to the X electrode Xi, and “Ye” indicates a voltage waveform related to the Y electrode Yi of the even display line.

The example shown in FIG. 18A is different from the example shown in FIG. 17A in the voltage waveform related to application of the sustain pulse. In the example shown in FIG. 18A, when the sustain pulses are applied to the X electrode Xi and the Y electrode Yi, the applied voltages to both the electrodes Xi and Yi are made to be in high levels, and thereafter the applied voltage of one of the electrodes Xi and Yi is set down to be in a low level.

In a case that the plasma display device is driven with the sustain pulse being applied as shown in FIG. 18A, if the switch SW1 is made from in an ON state to in an OFF state to bring about a high impedance state after the applied voltage to the Y electrode Yi (Ye) of the even display line is made to be in the high level, an error discharge may occur between the X electrode Xi and the Y electrode Yi (Ye) as shown in reference waveforms in FIG. 18B.

Thus, when the plasma display device is driven as shown in FIG. 18A, transition from the first sustain period to the second sustain period is done at a voltage state where a final sustain discharge in the fist sustain period is performed, that is, the applied voltage to the Y electrode Yi (Ye) of the even display line is in the low level. In other words, in the sate that the applied voltage to the Y electrode Yi (Ye) of the even display line is made to be in the low level, the switch SW1 is made to be from in the ON state to in the OFF state to make the Y electrode Yi (Ye) of the even display line be in the high impedance state. Thereby, in the second sustain period, occurrence of an error discharge between the X electrode Xi and the Y electrode Yi (Ye) of the even display line can be restrained, so that deterioration of a display quality (a drive margin) can be prevented.

In the above-described explanation, a sub-frame constituting the odd frame is explained. The same things apply to a sub-frame constituting the even frame, in a first sustain period of the even frame, both the switch SW1 to connect the scan circuit (even) 21 and the sustain circuit 23 and the switch SW2 to connect the scan circuit (odd) 22 and the sustain circuit 23 are made to be in the ON states. In the second sustain period of the even frame, the switch SW1 is made to be in the ON state and the switch SW2 is made to be in the OFF state. In other words, in the sub-frame of the even frame, the Y electrode Yi (Yo) of the odd display line becomes high impedance in the second sustain period.

As stated above, according to the third embodiment, in the Y electrode driver 20, the scan circuit (even) 21 corresponding to the even display line and the sustain circuit 23 are connected via the switch SW1 and the scan circuit (odd) 22 corresponding to the odd display line and the sustain circuit 23 are connected via the switch SW2. Then, in the first sustain periods of the odd frame and the even frame, both the switches SW1 and SW2 are made to be in the ON states and display operations are simultaneously performed with the two lines being a set. Here, when the two lines being the set are regarded as one line, display of the odd frame and display of the even frame are different in display line positions. Therefore, in the first sustain period, an interlace drive with two line display is realized.

In the second sustain period of the odd frame, the switch SW1 is made to be in the OFF state, while in the second sustain period of the even frame, the switch SW2 is made to be in the OFF state. In this way, in the second sustain period of the odd frame, the Y electrode Yi (Ye) of the even display line is made to be in the high impedance state to restrain the discharge in the even display line, while in the second sustain period of the even frame, the Y electrode Yi (Yo) of the odd display line is made to be in the high impedance state to restrain the discharge in the odd display line. Therefore, in the second sustain period, an interlace drive with one line display can be realized.

In the first and second sustain periods, a voltage waveform applied to the Y electrode (Ye, Yo) by the sustain circuit 23 in the Y electrode driver 20 and a voltage waveform applied to the X electrode Xi by the sustain circuit 31 in the X electrode driver 30 are one kind respectively. Therefore, it suffices to provide the Y electrode driver 20 and the X electrode driver 30 with one monophase sustain circuit respectively as each of sustain circuit 23 and the sustain circuit 31, so that the interlace drive becomes feasible with a simple circuit configuration.

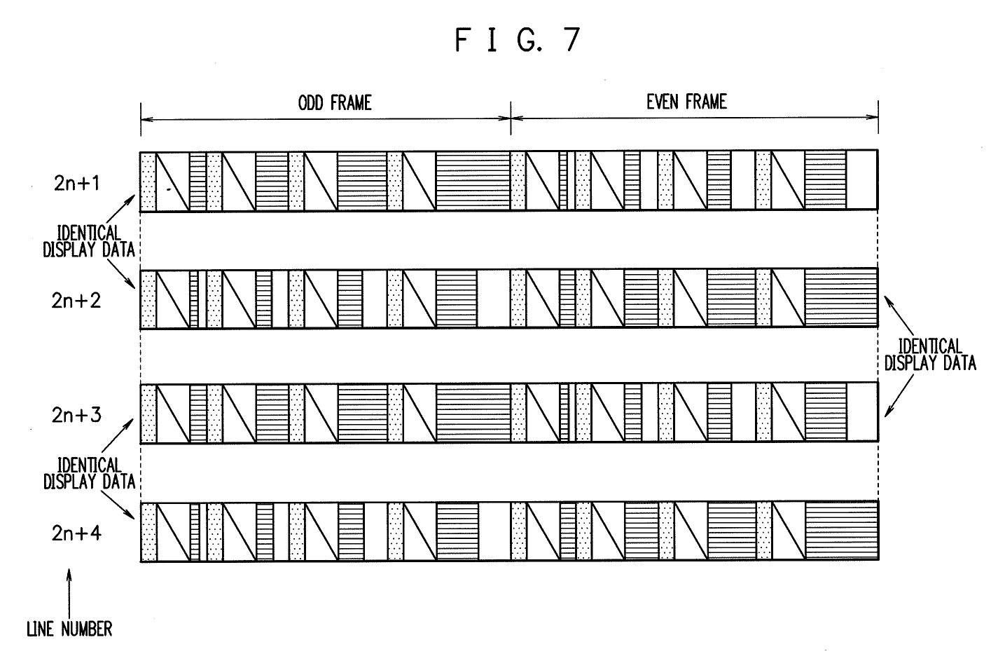

As stated above, in the second and third embodiment, two line display is partially performed and higher luminance can be attained than in the first embodiment. A drive configuration in the second embodiment is shown in FIG. 7. A display discharge number of one (lower one in FIG. 7, but a reverse case may be possible) of two lines to be a set is made to be smaller than that of the other one by a predetermined ratio. Thereby, an image becomes that of between one line display and two line display. Now, a ratio of a smaller sustain discharge number to the other sustain discharge number, that is, a temporal ratio of the first sustain period to (first sustain period+second sustain period) is defined as α. In other words, a mixing ratio indicating a ratio of two line lighting is defined as α. It is defined that 0<α<1.

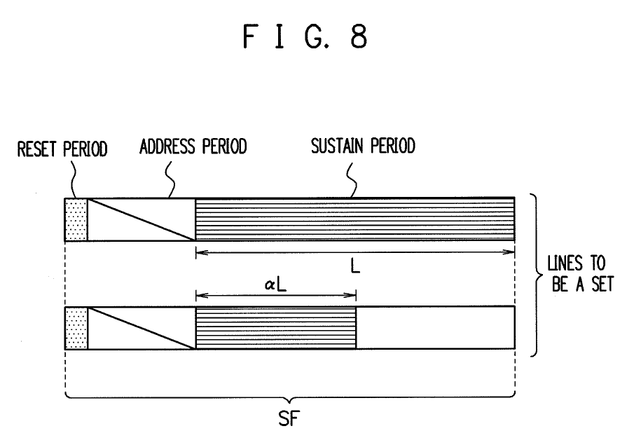

As shown in one sub-frame in FIG. 8 extracted from the drive configuration, when, in a certain sub-frame, a luminance at a time that a line in which the sustain discharge number is not decreased is all lighted is defined as L, a luminance at a time that the other line is all lighted is αL. Even if there is manufacturing variability, α is required to be desirably 0.05 or more in order to attain luminance improvement. Further, in order to attain a further effect of the luminance improvement, α is required to be desirably 0.2 or more. On the other hand, in order to attain an improvement effect of resolution, α is required to be desirably 0.8 or less, and more preferably α is desirable to be 0.5 or less.

Hereinafter, an example of a setting technique of the mixing ratio α will be described.

It should be noted that in the example described below, though a mixing ratio α is linearly changed in relation to a change of a display load ratio of a plasma display panel, changing is not limited thereto and changing of the mixing ratio α in relation to changing of the display load ratio may be non-linear.

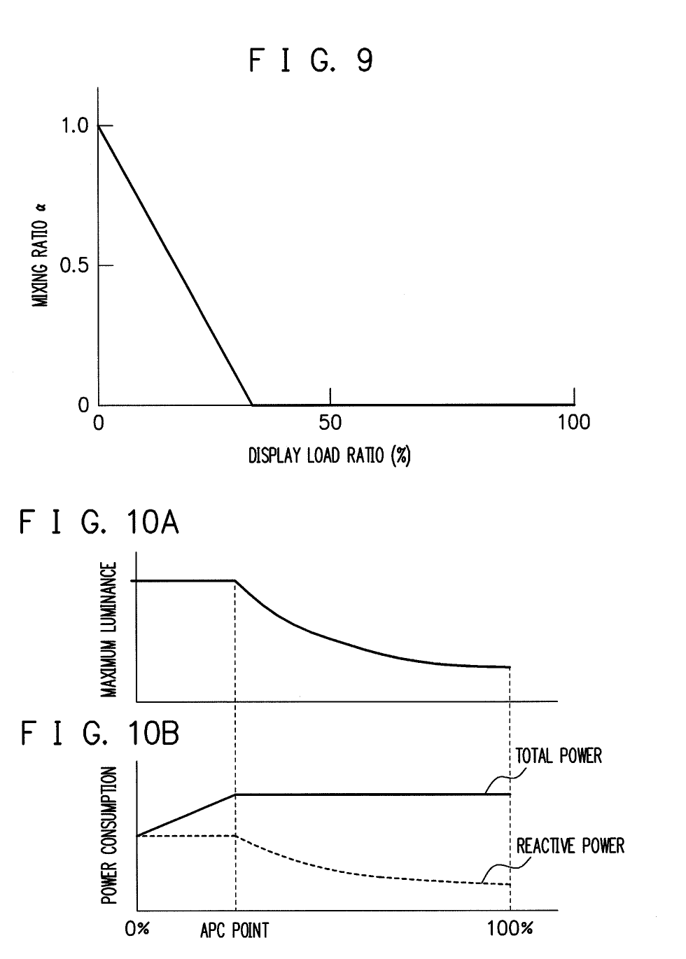

(1) As shown in FIG. 9, when a display load ratio of a plasma display panel is larger than a certain value (a first threshold value), a mixing ratio α of two line lighting is set to be “0” (zero). When the display load ratio is equal to or smaller than the first threshold value, the mixing ratio α is gradually increased as the display load ratio decreases.

When two line display is performed, a luminance per unit sustain period increases almost in proportion to the mixing ratio α of the two line lighting, but a light emission efficiency is almost the same. On the other hand, in a usual plasma display panel, APC (Automatic Power Control) control shown in FIG. 10A and FIG. 10B is performed.

Hereinafter, the APC control in the plasma display panel will be described. It should be noted that since the essence of the discussion is not changed, power consumption of the plasma display panel is assumed to be only electric power consumed in the sustain period, for convenience of explanation. Here, the electric power consumed in the sustain period is constituted with discharge electric power directly contributing to lighting and reactive power consumed at a time that capacitance between electrodes is charged and discharged. Relations of a maximum luminance (luminance at a highest tone) and power consumption to the display load ratio are shown in FIG. 10A and FIG. 10B. The maximum luminance and the reactive power are almost proportional to a sustain frequency, and under an APC point (usually, the display load ratio is 10% to 20%) the sustain frequency (the maximum luminance and the reactive power) is maintained constant, and above the APC point the sustain frequency (the maximum luminance and the reactive power) decreases as the display load ratio rises. On the other hand, total power rises as the display load ratio rises under the APC point and the total power is maintained constant above the APC point. This is the APC control usually performed.

Therefore, even if two line lighting is performed in a region of a high display load ratio (for example, in a region above the APC point), where control is performed to maintain the total power constant, the resolution decreases in relation to one line lighting and an effect of luminance rise is hardly expected. This is because by the two line lighting, though the luminance per one sustain period almost doubles, the power consumption also increases, so that under the control to maintain the total power constant a sustain frequency number at a two line lighting time decreases compared with a sustain frequency number at a one line lighting time, and as a result the maximum luminance hardly increases.

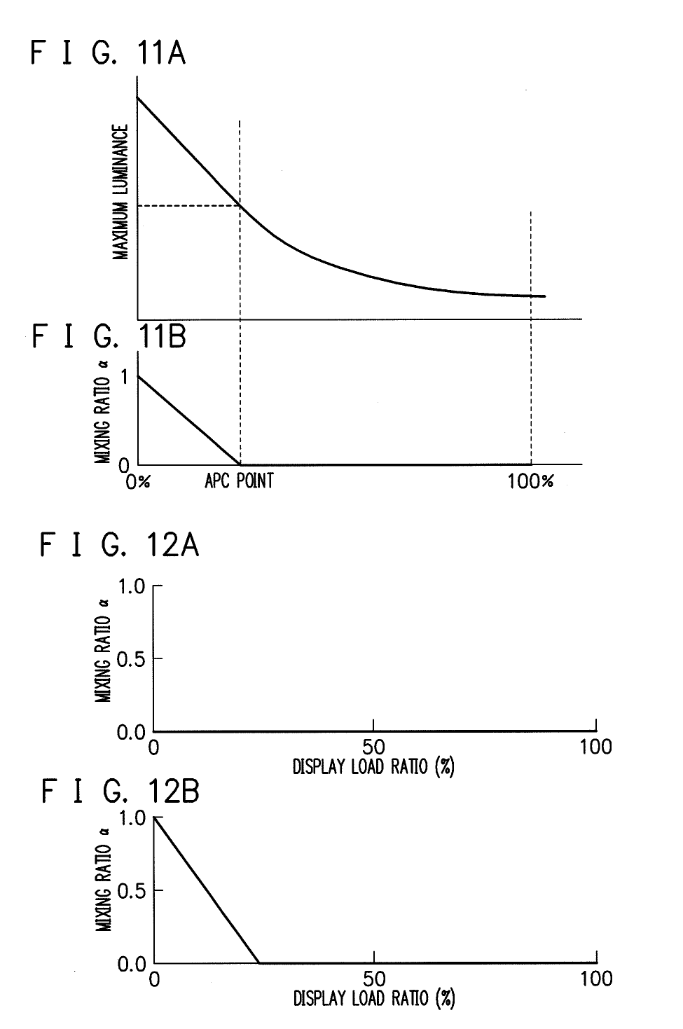

Under the circumstances, in a case that the display load ratio of the plasma display panel is equal to or lower than the first threshold value, control of two line lighting is performed. As an example, there is shown in FIG. 11A and FIG. 11B a maximum luminance (a luminance at a highest tone) and a mixing ratio α in relation to a display load ratio in a case that control is performed to increase the mixing ratio α of two line lighting along decrease of the display load ratio in a region where the display load ratio is lower than the APC point. In the region where the display load ratio is lower than the APC point, by increasing the mixing ratio α of two line lighting in correspondence with the display load ratio, the maximum luminance also increases.

(2) As shown in FIG. 12A and FIG. 12B, control of two line lighting is not performed in a lower sub-frame whose luminance weight is light (FIG. 12A), and control of two line lighting is performed only in an upper sub-frame whose luminance weight is heavy (FIG. 12B). In other words, in the lower sub-frame, the mixing ratio α of two line lighting is always set to be “0” (zero) regardless of the display load ratio of the plasma display panel. In the upper sub-frame, the mixing ratio α of two line lighting is set to be “0” (zero) when the display load ratio is higher than a certain value (a first threshold value), while the mixing ratio α is gradually increased as the display load ratio decreases when the display load ratio is equal to or less than the first threshold value.

In the above-described setting technique (1), the mixing ratios α of two line lighting are uniformly controlled in all the sub-frames, but in the lower sub-frame whose luminance weight is light, the effect of performing two line lighting is small since the sustain discharge number (sustain pulse number) is small (a drive time hardly increases even if the total pulse number is increased for the sake of luminance increase with keeping one line lighting). In order to output tones minutely, it is more important to make a minimum luminance small than to perform two line lighting in the lower sub-frame. Thus, in the lower sub-frame, control of two line lighting is not performed as shown in FIG. 12A, but control of two line lighting in correspondence with the display load ratio is performed in the upper sub-frame as shown in FIG. 12B.

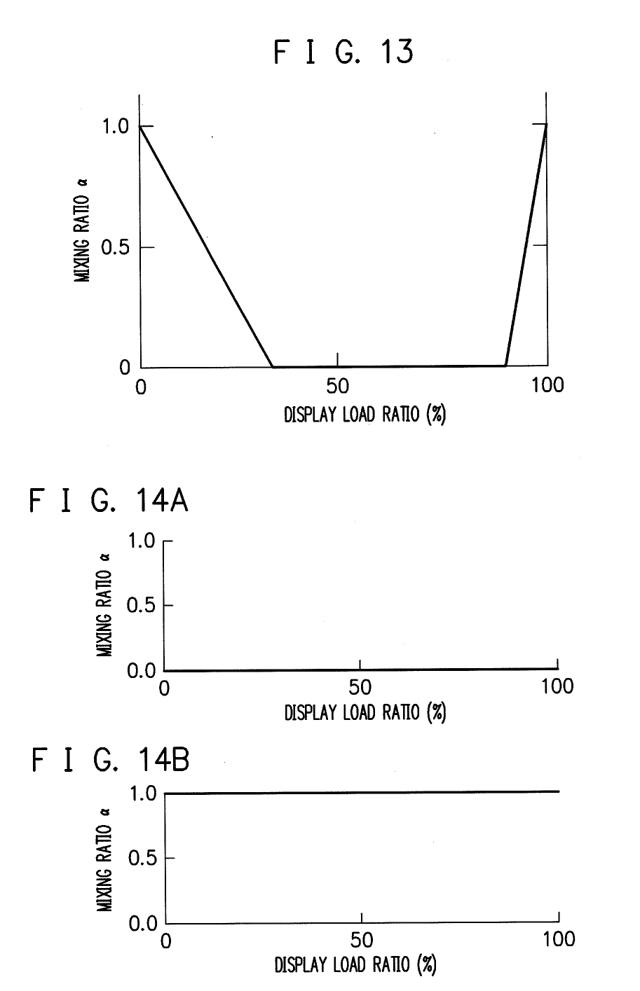

(3) As shown in FIG. 13, when a display load ratio of a plasma display panel is equal to or lower than a first threshold value, a mixing ratio α is gradually increased as the display load ratio decreases, when the display load ratio is higher than the first threshold value and equal to or lower than a second threshold value, the mixing ratio α of two line lighting is set to be “0” (zero), and when the display load ratio is higher than the second threshold value, the mixing ratio α is gradually increased as the display load value rises.

In a region of a high display load ratio, since control is performed to maintain the total power constant in APC control as described above, significant luminance improvement by two line lighting is not brought about. However, at a time of one line lighting, reactive power consumption by charging and discharging to line-to-line capacitance occurs even if a non-lighting line is not lighting. Therefore, two line lighting leads to decrease of a value of reactive power to the lighting cell number, and luminance can rise for the decrease of the reactive power. In a region in which the display load ratio is approximately 100%, a whole screen is almost all white and much resolution is not required.

Thus, in the region in which the display load ratio is approximately 100%, where much resolution is not required, the mixing ratio α of two line lighting is increased in correspondence with the display load ratio, whereby it becomes possible to reduce the reactive power and to improve the luminance.

### Fourth Embodiment

Next, a fourth embodiment of the present invention will be described.

A configuration of a plasma display device in the fourth embodiment is similar to the configuration of the plasma display device in the first embodiment, and explanation thereof will be omitted.

In the fourth embodiment, as shown in FIG. 14A and FIG. 14B, regardless of a display load ratio, control of two line lighting is not performed at all in a lower sub-frame whose luminance weight is light (FIG. 14A), while control of two line lighting is performed in an upper sub-frame whose luminance weight is heavy (FIG. 14B). In the lower sub-frame, one line lighting is performed with a mixing ratio αalways being “0” (zero), while in the upper sub-frame, two line lighting is performed with the mixing ratio α always being “1”.

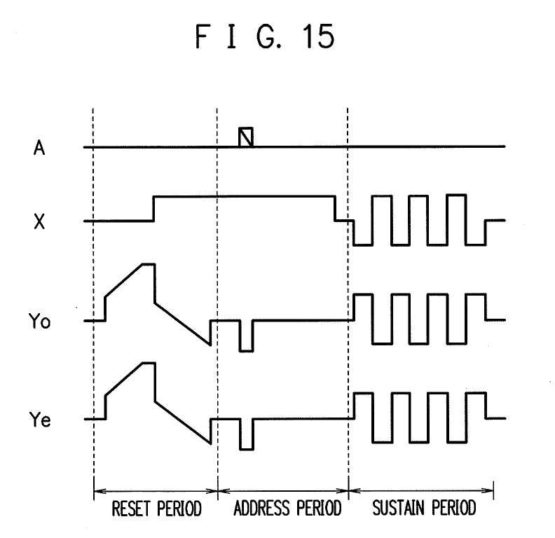

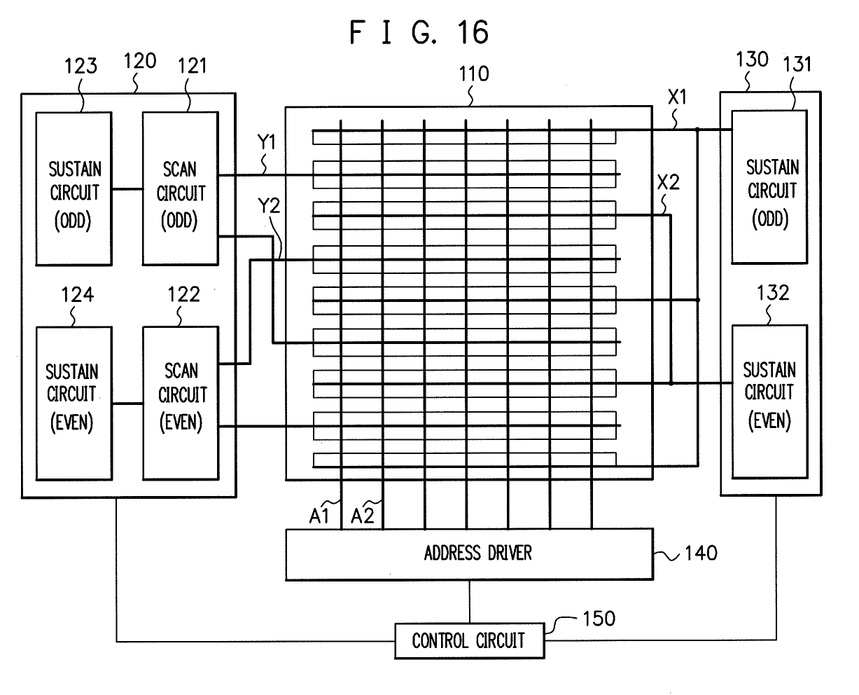

The plasma display device in the fourth embodiment is driven in accordance with the drive waveforms shown in FIG. 5 in the lower sub-frame in which the mixing ratio α is “0” (zero), and is driven in accordance with the drive waveforms shown in FIG. 15 in the upper sub-frame in which the mixing ratio is “1”. It should be noted that the drive waveform example shown in FIG. 15 is similar to the waveforms shown in FIG. 6 except that in the waveforms in FIG. 15 the second sustain period does not exist and the first sustain period occupies the entire sustain period. In a reset period and an address period of the lower sub-frame in which the mixing ratio α is “0” (zero), a Y electrode Yi (Ye) of an even display line or a Y electrode (Yo) of an odd display line may be made to be high impedance as in the example shown in FIG. 5, and data same as that of a neighboring lighting line may be written as in the example shown in FIG. 6.

According to the fourth embodiment, similarly to in the first to third embodiments, it is possible to realize an interlace drive with a simple circuit configuration without complicating the circuit configuration. Further, by switching whether or not to perform control of two line lighting in correspondence with whether the lower sub-frame or the upper sub-frame regardless of a display load ratio, it is also possible to simplify a circuit configuration regarding the control of two line lighting.

It should be noted that in the examples of the above-described second to fourth embodiments the mixing ratio α can be any value in a range of “0” (zero) to “1”, but the present invention is not limited thereto. For example, it may be controlled that the mixing ratio α does not become a value equal to or less than 0.2 and it may be controlled that the mixing ratio α does not become a value equal to or more than 0.8.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device, comprising:
a plasma display panel in which one display line is constituted with a display electrode pair made of two electrodes and the display electrode pair of an even display line and the display electrode pair of an odd display line are alternately arranged;
a first scan circuit connected to a scan electrode of the display electrode pair of the even display line and supplying a drive voltage to the scan electrode;
a second scan circuit connected to a scan electrode of the display electrode pair of the odd display line and supplying a drive voltage to the scan electrode;
a first sustain circuit outputting one kind of sustain pulse applied to the scan electrode of the display electrode pair;
a first switch circuit being a switch circuit connecting said first sustain circuit and said first scan circuit and capable of making the scan electrode of the even display line be in a high impedance state; and
a second switch circuit being a switch circuit connecting said first sustain circuit and said second scan circuit and capable of making the scan electrode of the odd display line be in the high impedance state.

2. The plasma display device according to claim 1, wherein
one frame is constituted with a plurality of sub-frames and each sub-frame has a sustain period in which a cell selected in correspondence with display data is made to perform discharge light emission, and
the scan electrode of the odd display line is made to be in the high impedance state by the second switch circuit in at least the sustain period of an even frame, and the scan electrode of the even display line is made to be in the high impedance state by the first switch circuit in at least the sustain period of an odd frame.

3. The plasma display device according to claim 2, wherein
the scan electrode to be made to be in the high impedance state is made in the high impedance state in the whole sustain period.

4. The plasma display device according to claim 2, wherein
the each sub-frame has an address period in which selection of the cell to be lighted is performed in correspondence with the display data, and
the same data is written to the corresponding cells of neighboring two display lines, in the address period of at least one sub-frame.

5. The plasma display device according to claim 4, wherein
a mixing ratio indicating a temporal ratio in the sustain period in which the sustain pulses are simultaneously applied to the scan electrode of the even display line and the scan electrode of the odd display line in the sustain period is controlled in correspondence with a display load ratio of said plasma display panel.

6. The plasma display device according to claim 5, wherein
the mixing ratio is increased as the display load ratio of said plasma display panel decreases when the display load ratio is equal to or lower than a first threshold value, and the mixing ratio is set to be “0” (zero) when the display load ratio is higher than the first threshold value.

7. The plasma display device according to claim 5, wherein
the mixing ratio is increased as the display load ratio of said plasma display panel decreases when the display load ratio is equal to or lower than a first threshold value, the mixing ratio is set to be “0” (zero) when the display load ratio is higher than the first threshold value and equal to or lower than a second threshold value, and the mixing ratio is increased as the display load ratio increases when the display load ratio is higher than the second threshold value.

8. The plasma display device according to claim 6, wherein
the mixing ratio is set to be “0” (zero) regardless of the display load ratio of said plasma display panel in the sub-frame whose luminance weight is light.

9. The plasma display device according to claim 4, wherein
a mixing ratio indicating a temporal ratio in the sustain period in which the sustain pulses are simultaneously applied to the scan electrode of the even display line and the scan electrode of the odd display line in the sustain period is set to be “0” (zero) in the sub-frame whose luminance weight is light and set to be “1” in the sub-frame whose luminance weight is heavy.

10. The plasma display device according to claim 1, wherein
the scan electrodes of the display electrode pair in the neighboring display lines are adjacently disposed to each other in said plasma display panel.

11. The plasma display device according to claim 1, comprising
a second sustain circuit to which electrodes different from the scan electrodes in each display electrode pair of the even display line and the odd display line are commonly connected and outputting one kind of sustain pulse applied to the electrode.

12. The plasma display device according to claim 1, wherein
one frame is constituted with a plurality of sub-frames and each sub-frame has a sustain period in which a cell selected in correspondence with display data is made to perform discharge light emission, and the sustain period is constituted with a first sustain period and a second sustain period,
wherein in the first sustain period, the sustain pulses are simultaneously applied to the scan electrode of the even display line and the scan electrode of the odd display line, and in the second sustain period, the scan electrode of the odd display line is made to be in the high impedance state by said second switch circuit in a case of even frame display and the scan electrode of the even display line is made to be in the high impedance state by said first switch circuit in a case of odd frame display, and
transition is performed from the first sustain period to the second sustain period in a voltage state in which a final sustain discharge in the first sustain period is performed.

13. The plasma display device according to claim 12, wherein
in applying the sustain pulses to the display electrode pair, when both voltages applied to the two electrodes of the display electrode pair are made to be low level and thereafter drive is performed in a manner that the voltage applied to one of the electrodes is set up, transition from the first sustain period to the second sustain period is performed with the applied voltage of the scan electrode is in a state of high level.

14. The plasma display device according to claim 12, wherein
in applying the sustain pulses to the display electrode pair, when both voltages applied to two electrodes of the display electrode pair are made to be high level and thereafter drive is performed in a manner that the voltage applied to one of the electrodes is set down, transition from the first sustain period to the second sustain period is performed with the applied voltage of the scan electrode is in a state of low level.

15. The plasma display device according to claim 12, wherein
a mixing ratio indicating a temporal ratio of the first sustain period in the sustain period is controlled in correspondence with a display load ratio of said plasma display panel.

16. The plasma display device according to claim 12, wherein
the each sub-frame has an address period in which a cell to be lighted is selected in correspondence with the display data, and
the same data is written to cells corresponding to neighboring two display lines in the address period.
